(19) United States
(12) Patent Application Publication
(10) Pub. No.: US 2016/0142366 A1
(43) Pub. Date: May 19, 2016

(54) METHOD AND SYSTEM FOR AUTOMATIC PROVISIONING OF ENTERPRISE PRIVATE NETWORK OVER 3G/4G MOBILE WIRELESS NETWORKS WHILE MAINTAINING RESPECTIVELY CONSISTENT IDENTITIES

(71) Applicant: Brocade Communications Systems, Inc., San Jose, CA (US)

(72) Inventors: Nishi Kant, Fremont, CA (US); Heeseon Lim, Cupertino, CA (US)

(73) Assignee: CONNECTEM INC., Santa Clara, CA (US)

(21) Appl. No.: 13/763,653

(22) Filed: Feb. 9, 2013

(51) Int. Cl. H04L 29/12; H04W 40/24; H04W 40/32

(52) U.S. Cl. CPC H04L 61/106; H04W 40/32; H04W 40/246; H04W 84/12

(57) ABSTRACT

An intelligent mechanism to map the public user identity into the private user identity inside the mobile network is defined. The identity mapping logic supports M:N mapping where M and N can be any natural number while a user or device can still be identified without ambiguity in the network and all the protocols are handled according to the standard specifications. Such ID mapping can be used to create virtual private networks, to provide flexibility in usage of identities, to save the scarce type of identities, and to map the identities between private enterprise identity and mobile network identity. As a result MSIDSN translation, support of private static IP address and support for network initiated communication becomes much easier.

### CROSS REFERENCE TO RELATED APPLICATIONS

The present application claims the benefit of U.S. Provisional Application No. 61/596,738, filed on Feb. 9, 2012 by the present inventors, which is herein incorporated by reference.

### FIELD OF THE INVENTION

The present invention relates generally to mobile wireless networks which includes general packet radio service (GPRS) networks, UMTS and LTE. Specifically, this invention relates to a method for automatic provisioning of a private network over a macro mobile wireless network while maintaining private identities used in the private network.

### BACKGROUND

The GPRS or universal mobile telecommunications system (UMTS) is an evolution of the global system for mobile communications (GSM) standard to provide packet switched data services to GSM mobile stations. Packet-switched data services are used for transmitting chunks of data or for data transfers of an intermittent or bursty nature. Typical applications for 3GPP packet service include Internet browsing, wireless e-mail, video streaming, and credit card processing, etc. used by human users. The 3GPP packet service could also be used to connect mobile devices to packet data networks owned by organization such as government and enterprises. FIG. 1 shows 3GPP network (3G UMTS and 4G LTE) connecting mobile devices such to the Internet as well as private data network.

The mobile network uses a few identities such as MSISDN (Mobile Station International Subscriber Directory Number), IMSI (International Mobile Subscriber Identity), IMEI (International Mobile Equipment Identity), or P-TMSI (packet network temporary mobile subscriber identity), etc. These identities are owned by Mobile Network Operator and exist in order to fulfill protocol needs, addressability or identification needs. The MSISDN commonly known as the phone number is a public identity that is used to reach the subscriber from the mobile network and PSTN (Public Switched Telephone Network). In packet communication IP address represents the network address nevertheless the MSISDN is still used more for protocol compatibility rather than for any real need. The IMSI is a private identity used by mobile network to identify a subscriber inside the network. Similarly IMEI is used to identify a device itself, i.e. the IMEI is tied to the handset. The IMSI is permanently programmed into the SIM (Subscriber Identity Module). Since IMSI is private identity, a temporary identity called TMSI (Temporary Mobile Subscriber Identity) or P-TMSI (Packet TMSI) is used to minimize the use of IMSI in the network signaling protocols over the air. The identities and their relative association to physical entity are shown in FIG. 2. Mobile network operator's internal identities like IMSI 221, TMSI 222, or P-TMSI 223 are usually tied with the user's SIM module 220. An identity for each user equipment hardware 210 is called IMEI 211. Public identities for mobile operators or external entities to locate and address the device 200 include MSISDN 201, device serial ID 202 used by the external applications or servers, or IP address 203. Traditionally, the public and private identities association has followed the rules of encoding for each identity. With number portability use of external databases and complex procedures are required to map a given phone number (MSISDN) to the network's private subscriber identity (IMSI). Secondly MSISDN are allocated globally by country specific authority and it is usually not cost-efficient to allocate an MSISDN to devices like data card or a vending machine.

Organizations both private & government that are Local & Global are looking for new and innovative ways to manage their business & operations at an optimum cost structure. There are many use-cases including disaster management, lifestyle, telematics, performance management and remote monitoring where sensors with communication capability could be effectively used. Similarly Enterprises could you computing devices like tablets, PCs, eBook etc. for sharing and disseminating enterprise content for business reasons or for productivity gains. Whenever a large entity such as government or corporation wants to use mobile network for connecting the devices that they own, there is a desire and need for these devices to be seen as virtual private network. Such private network is then seen as the extension of respective organization's own network. The organizations can manage and communicate with these devices exclusively with the identities they own and understand. For data applications, device identity and IP address should be sufficient.

In early days of mobile wireless technology, the voice was the main service and MSIDN was the only identity that was needed externally for users and businesses. Moreover, the subscriber and service relationship was exclusively between the mobile user and the mobile network operator. With advent of mobile data, this started to change, for many data applications the same user has subscription relationship with third parties. The data services are typically built on Internet Protocol (IP) and therefore the user devices needs an IP address an identity. If the mobile device connects with more than one packet data network, it will have multiple IP addresses. A Smartphone that is used both for traditional voice calling and for data applications uses all these identities. There are several “data only” devices such as PC cards, USB dongles, kindle, tablet and M2M (machine to machine) modem that are not involved in traditional voice calling. These devices do not need a phone number (MSISDN). They almost always have a subscription/service relationship beyond mobile network operator. Such third party entities will like to address and communicate with devices exactly they do over any other public IP network including Internet. Thus the enterprise that owns the M2M modems in the vending machines and smartmeters would want to assign it an identity as per their scheme and make it part of their private IP network. In other word they would want to overlay a Virtual Private Network (VPN) over the mobile wireless network. As the nature and scope of mobile communications has evolved (from voice to data apps, from handset to M2M modem) the need for identities has changed as well. Some identities are not required in some cases while in some other cases, more flexibility with identities is needed. Traditional network is carrying the burden and cost of provisioning unnecessary identities and at the same time is unable to provide flexibility in order to support frequently occurring use cases. For example, enterprises use static private IP addresses for devices that need to be reached at any time. Today's traditional mobile wireless network cannot support this use case. It can only support static IP address when they are public. Public IP addresses are expensive and may not help with private networking that Enterprise wants to have. This invention solves such problems.

FIG. 1 is a block diagram illustrating generic interconnection of GPRS network with external Packet Data Networks (PDNs) such as private networks owned by enterprises/government and the public Internet. Referring to FIG. 1, mobile devices 101-103 are communicatively coupled to a core network 110. For example, voice handset 101 is coupled to the core network 110 via a 3G Radio access network through e.g. nodeB or NB 104 and radio network controller (RNC) 105 and from there to a Mobile Switching Center (MSC) 115 and through Gateway-MSC (GMSC) 116 to the PSTN 122. The voice handset 101 does not need services from packet core nodes such as SGSN 111. The smartphone 102 is additionally coupled to the core network 110 via a corresponding long term evolution (LTE) access network (e.g., evolved UMTS terrestrial RAN (E-UTRAN) node B or eNB) 106. Finally the connected device 103 is coupled to Core 110 via RNC 105 or eNB 106. However, unlike handset 101 and smartphone 102, it does not need voice services from MSC 115, nevertheless it is required to register with MSC 115 in order to fulfill procedural needs. In order to communicate to a data service located in other networks such as Internet 120 and/or Enterprise premise 121, data devices 102-103 have to go through core network 110. Typically, core network 110 includes a serving GPRS support node (SGSN) 111 for 3G network or serving gateway (S-GW) 113 for LTE network 107 and a gateway GPRS support node (GGSN) 112 for 3G network or packet data network (PDN-GW) 114 for LTE network. These SGSN 111/S-GW 113 and GGSN 112/PDN-GW 114 relay communications between a machine type UE 102-103 and a destination (e.g. Enterprise server) 120-121. A typical core network also includes a home location register (HLR) or home subscriber server (HSS) 117 storing subscription profile and a policy and charging rule function (PCRF) 118. As mentioned before for circuit switched voice services it includes MSC 115 and G-MSC 116.

### SUMMARY OF THE DESCRIPTION

A structured information storage in a packet core network is defined. First level of the hierarchical structure stores the common attribute in a set of devices or subscribers, such has devices belonging to an organization. This common association attribute becomes a handle that is used to create constructs of private virtual network for a set of devices. This group level attribute has a group ID as an identifier. A subgroup level common attribute can also be present can be used to create further subnets. The device and subscriber information in the repository exist as per 3GPP requirements.

Some of the identities used need to be unique only within the private network e.g. IP address or device identifier The above said private network provides organizations complete freedom how to use such identities. This invention provides a mapping between identities that organizations want to use and the unique private identity like IMSI.

By virtue of the above capability, this invention allows network initiated communication using any identity that is known to connected organizations.

### BRIEF DESCRIPTION OF THE DRAWINGS

The present invention is illustrated by way of example and not limitation in the figures of the accompanying drawings in which like references indicate similar elements.

FIG. 1 is a block diagram illustrating mobile communications over typical 3GPP core network and the interconnection with RAN and external networks (PSTN, Internet or Enterprise network.)

FIG. 2 is a block diagram illustrating identities used in such a system.

FIG. 3 is a block diagram illustrating a 3GPP packet system according to one embodiment.

FIG. 4 is a block diagram illustrating a process for routing 3GPP data packets over a virtual private network.

FIG. 5 is depiction of end to end 3GPP network using virtual optimized core (VOC) as the packet core with ID mapping module. It also shows creation of Virtual Private Network (VPN) according to one embodiment of this invention.

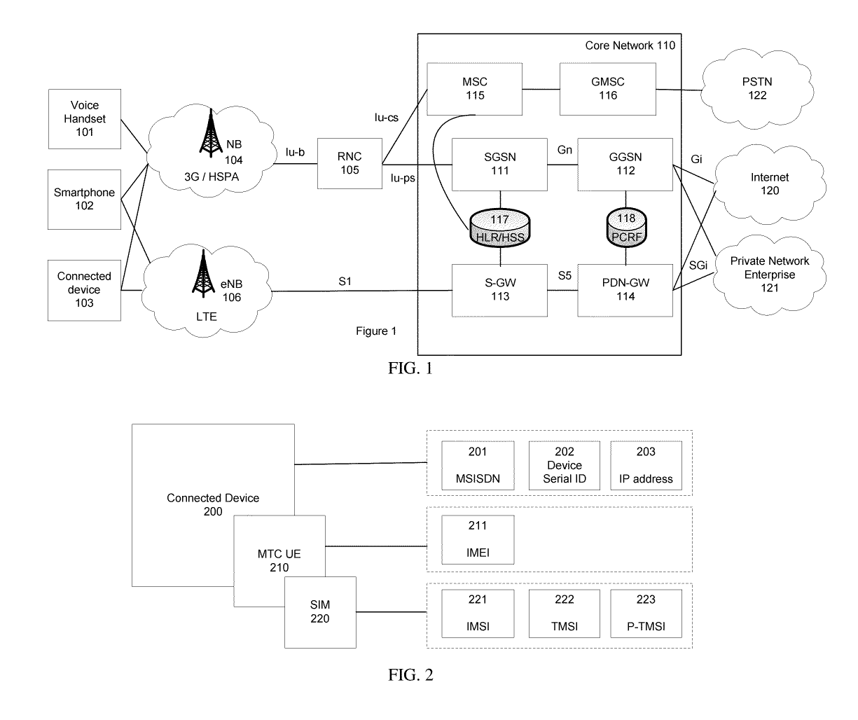

### DETAILED DESCRIPTION

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

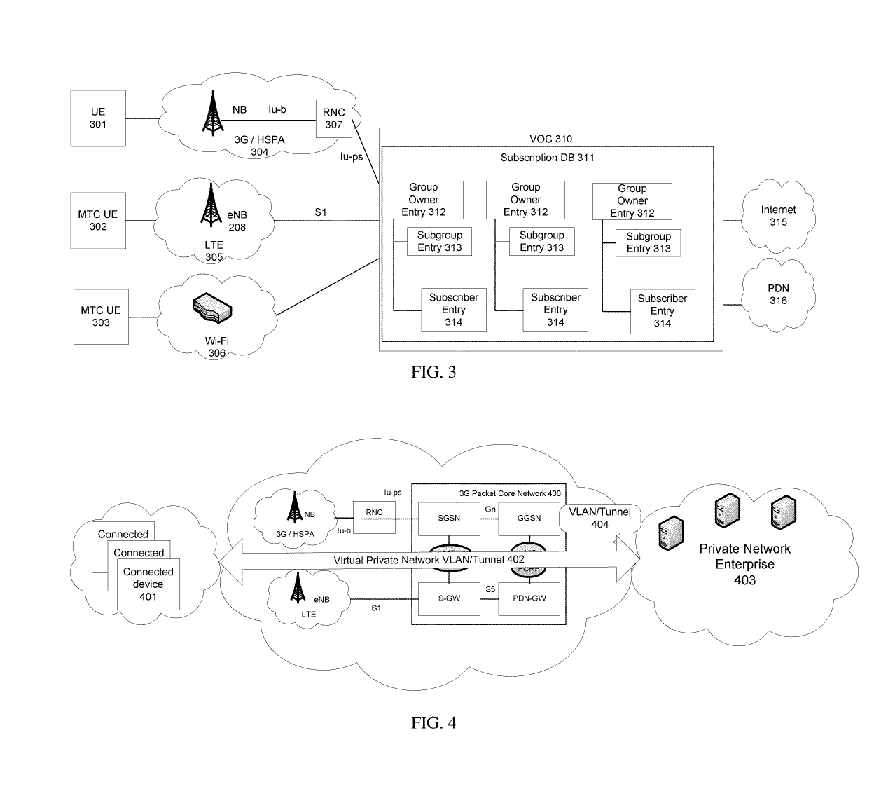

According to one embodiment, a system Virtual Optimized Core (VOC) 310 is augmented with a mechanism to automatically tag the persistent data associated with a subscriber or a device with one or more handles representing the responsible organization 312 or subgroup 313. (e.g. for all modems integrated in smart vending machines belonging to Coke is tagged with “Coke” or “Coke-vending-machine”.) The tag serves as a handle to define a private data network at any time needed. This is illustrated in FIG. 3.

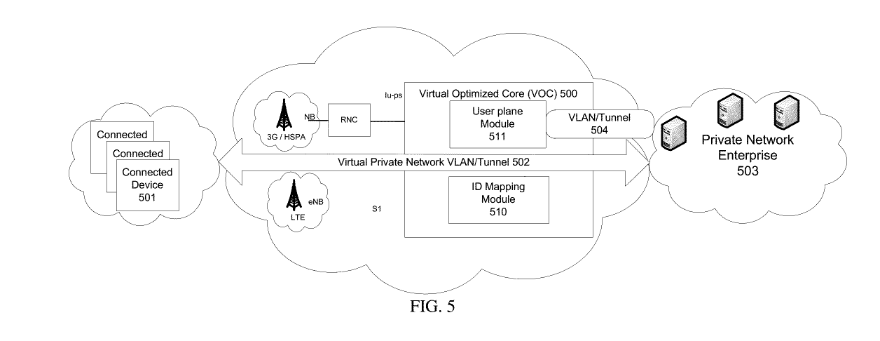

According to one embodiment, the existence of above-said handle is used to create exclusive connection and information exchange between these devices and private enterprise network. In FIG. 5, the handle can map into a VLAN or a tunnel 504 between user plane entity 511 of the VOC 500 and the private network 503. A mechanism is provided to allow subgroup handle to map into a subnet. In essence, this creates a virtual private network 502 between the private network enterprise 503 and the connected devices 501. The Id mapping module 510 allows use of private “MSISDN”. For non voice application, private MSISDN is used just to fulfill protocol needs. However the same mechanism allows for expansion of MSISDN space for use in Voice of IP applications including VoLTE. The ID mapping module 510 has a public MSISDN. From traditional external network (e.g. PSTN) the dialed MSISDN is pointed to ID mapping module 510. Upon call completion, the ID mapping module 510 collects additional digits. These additional digits map into a private MSISDN. From SIP enabled network, the extended identity can be carried along with recipient i.e. Id mapping functions address.

In one embodiment the binding association inside the Id mapping function can be created at the provisioning time. In some other embodiment such association can be created dynamically.

In one embodiment, mechanism is provided to create or assign private static IP addresses to the device. The group or subgroup handle create unique address space. The mechanism allows for use of IETF private IP addresses 10.0.0.0, 172.16.0.0, or 192.168.0.0 in each private network identified by the handle. Such address space is confined to VLAN/Tunnel specific to each group or subgroup. The Id mapping module 510 associates IP address to IMSI.

In one embodiment of this invention, a mechanism is provided for assigning Static private IP addresses to mobile devices belonging to group or subgroup owned by external organization. The VOC accepts private static IP address to IMSI mapping defining the association and makes it persistent.

In some embodiment a mechanism is provided to initiate the communication from the external network. The external network must direct communication to the Id mapping function or to an address known to Id mapping function.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable medium. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine-implemented method performed within a network element for processing network signaling of a packet core network, the method comprising:
configuring a group or subgroup attribute in user or device subscription data and a logic to link the group attribute to data to private networking construct;
configuring a layer 2 or layer 3 construct linked to group attribute;
providing switching or routing to a network domain linked to group or subgroup attribute.

2. The method of claim 1, wherein non-configuration of a explicit group attribute defaults to built-in value.

3. The method of claim 1, further comprising mapping specific identities of a network domain linked to a group or subgroup within a context of the group or subgroup to one or more mobile network specific identities.

4. The method of claim 3, wherein the said mapping can be done using static mapping information via provisioning or can be done using mapping information obtained dynamically during signaling exchange between the devices and a network.

5. The method of claim 1, wherein the components of the packet core network are one of a serving general packet radio service (GPRS) support node (SGSN) or Mobility Management Entity (MME) or serving gateway (S-GW), one of gateway general packet radio service (GPRS) support node (GGSN) or packet data network gateway (PDN-GW), home location register (HLR), and policy and charging rule function (PCRF) of the packet core network.

6. The method of claim 1, further comprising routing a network traffic to and from a remote node if the packet is received from a UMTS access network and destined to the packet data network wherein the access interface logic is configured to handle Iu-PS signaling protocol.

7. The method of claim 1, further comprising routing a network traffic to and from a remote node if the packet is received from a long term evolution (LTE) access network and destined to the packet data network wherein the access interface logic is configured to handle S1 signaling protocol.

8. The method of claim 1, further comprising routing a network traffic to and from a remote node if the packet is received from a Wi-Fi access network and destined to the packet data network wherein the access interface logic is configured to handle 802.1x/802.11 signaling protocol.

9. The method of claim 1, further comprising:
in response to a request for accessing the network from a remote node to the network,
determining whether a remote node is associated with a group that has an associated external network; and
in response to a request for establishing a network communication between a remote node and the network element,
determining which group the remote node is associated with;
and applying this to session context for the duration of the session;
and making traffic flow decision based on a context information to the external network.

10. A network element for processing network traffic of a packet network, the network element comprising:
an access network interface unit to interface with a remote node via a various access network;
a subscription database unit with a hierarchical structure to store the subscription information in a group and subgroup level
and an IP interface unit to route the packet to a destination to enable the packet to reach the destination on an external packet data network.

11. The network element of claim 10, wherein the access network is further comprised of a 3G radio access network, high speed packet access (HSPA), long term evolution (LTE) access network or Wi-Fi access network.

12. The network element of claim 11 wherein the access network interface unit is configured to handle an Iu-ps signaling protocol, S1 signaling protocol, and 802.1x/802.11 signaling protocol.

13. The network element of claim 10, further comprising an ID mapping unit to map specific identities provided by an external packet data network with correct topology within the external network to one or more mobile network specific identities of the subscriber of device.

14. The network element in claim 13 wherein the ID mapping unit uses the information provided by the external network to dynamically construct identity or address and use such constructed identity or address, or maps the constructed address to a mobile network specific identity in order to establish communication between a mobile subscriber or device and a network.

15. The network element of claim 10, wherein the access network interface logic is further configured to include support of a 3G radio access network, high speed packet access (HSPA), long term evolution (LTE) access network or Wi-Fi access network.

16. The network element of claim 10, wherein the access network interface logic is further configured to handle an Iu-ps signaling protocol, S1 signaling protocol, and 802.1x/802.11x signaling protocol.

17. The network element of claim 14, wherein the ID mapping unit is further configured to perform:
in response to a request for accessing a wireless node from an external network,
determining whether a remote node is associated with a group that has an access to the network;
in response to a request for establishing a network communication between external network and wireless node,
determining which group the remote node is associated with;
constructing a context for the wireless node to be topologically correct part of the external network; and
applying the context information to all communication between the external network and wireless node.
